(19) United States
(12) Patent Application Publication
(10) Pub. No.: US 2006/0033064 A1
(43) Pub. Date: Feb. 16, 2006

(54) Valve arrangement

(76) Inventors: Sezgin Acar, Ludwigsburg (DE); Heike Bauer, Stuttgart (DE); Klaus Heyer, Freiberg (DE); Massimiliano Ambrosi, Marbach (DE); Dietmar Kratzer, Tamm (DE); Daniel Zuewerink, Ingolstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/173,160

(22) Filed: Jul. 5, 2005

(30) Foreign Application Priority Data
Jun. 24, 2004 (DE) 10 2004 030 425.4

(51) Int. Cl. F16K 31/02

(52) U.S. Cl. 251/129.19

(57) ABSTRACT

A valve arrangement having a valve element disposed longitudinally movably in a valve insert and cooperating with a valve seat in a valve body, which valve element in the installed position is acted upon, by a spring assembly disposed between the valve body and the valve insert, with a force component acting in the opening direction of the valve seat and is actuatable in the closing direction of the valve seat via an electromagnetic actuator. The spring assembly is guided in the radial direction in the region of a bearing face on the valve element. The spring assembly between its contact region on the valve element and its contact region on the valve body is guided in at least one further region in the radial direction on the valve insert.

### BACKGROUND OF THE INVENTION

1. Field of the Invention

The invention relates to an improved electromagnetically actuated valve arrangement of the type useful, for example, in brake systems of motor vehicles.

2. Description of the Prior Art

An electromagnetically actuatable valve arrangement, which is usable particularly in hydraulic brake systems of motor vehicles, is described in German Patent Disclosure DE 100 36 576 A1. The valve arrangement includes a valve insert embodied with a longitudinal bore and solidly connected to a valve dome. Disposed in the valve dome is an armature, longitudinally movable in the axial direction of the valve arrangement, that is operatively connected to a valve tappet guided longitudinally movably, likewise in the axial direction, in the valve insert. The operative connection between the armature and the valve tappet or the valve element is such that an armature motion in the closing direction of a valve seat is transmitted to the valve tappet embodied with a closing member, so that a seat valve is closed upon contact of the closing member with a valve seat.

Over the entire length of the longitudinal bore of the valve insert, the valve tappet is guided with slight radial play and is provided on its jacket side with at least two conduits, separate from one another. A valve chamber containing the seat valve of the valve arrangement communicates fluidically through the conduits with voids inside the valve dome, so that residual air in the valve dome can be positively displaced via the conduits.

The valve arrangement, in the currentless state, is furthermore kept in the opened state by a spring assembly or a restoring spring; the spring assembly, embodied as a compression spring, is built into the valve chamber. This disposition of the spring assembly assures simple assembly of the valve arrangement.

However, the spring assembly in the valve chamber is disadvantageously exposed to static and dynamic influences, which are caused by the operating medium flowing through the valve chamber and which impair the functioning of the valve arrangement. These influences are, among others, flow and deflection forces that are caused by the flow in the valve chamber and engage the spring windings of the compression spring; these forces vary considerably over the entire operating range of the valve arrangement and can therefore be replicated only with difficulty and cannot be predicted.

It is additionally disadvantageous that the spring assembly is installed in an undefined position in the valve chamber in the radial direction, and with regard to the positioning in the valve chamber has such tolerances and degrees of freedom that deviations in the closed- and open-loop control behavior result between structurally identical valve arrangements and even in one and the same valve, which however is unwanted.

For the above reasons, the mode of operation of a valve arrangement, or the valve behavior, is attainable only at considerable effort, but that disadvantageously means high costs.

### SUMMARY AND ADVANTAGES OF THE INVENTION

In the valve arrangement of the invention, which is embodied having a valve element disposed longitudinally movably in a valve insert and cooperating with a valve seat embodied in a valve body, which valve element in the installed position is acted upon, by a spring assembly disposed between the valve body and the valve insert, with a force component acting in the opening direction of the valve seat and can be actuated in the closing direction of the valve seat via an electromagnetic actuator, where at least part of the valve element is disposed in a valve chamber defined by the valve insert in the region of the valve seat, an impairment to the functioning of the valve arrangement is at least reduced, in comparison to the valve arrangements known from the prior art, in such a way that a desired, verifiable open- and closed-loop control characteristic of the valve arrangement is available over its entire operating range.

This is attained by providing that the spring assembly, between its contact region on the valve element and its contact region on the valve body, is guided in at least one further region in the radial direction on the valve insert. Thus the spring assembly is defined in its radial position, preferably by form-locking or force-locking, and as a result the open- and closed-loop control behavior, which in valve arrangements known from the prior art varies undesirably over the operating range of a valve arrangement, is improved by means of a reduction in degrees of freedom of the spring position and spring location in the interior of the valve insert. Effects associated with this, which result from static and dynamic influences, such as a change in force of the spring assembly from varying length ratios, the natural frequency, and a vibration behavior of the spring assembly or radial deflections of the spring assembly and their effects on components of the valve arrangement that are located adjacent to the spring assembly, are at least reduced or precluded to their full extent. Thus the open- and closed-loop control behavior of the valve arrangement can be determined in advance substantially more simply and precisely, and the open- and closed-loop effort and expense is reduced.

### BRIEF DESCRIPTION OF THE DRAWINGS

Further advantages and advantageous refinements of the subject of the invention will become apparent from the description contained herein below, taken in conjunction with the drawings, in which:

FIG. 1 is a schematic longitudinal section through a valve arrangement embodied according to the invention;

FIG. 2 is a region marked II in FIG. 1, shown enlarged;

FIG. 3 is the spring assembly shown in FIG. 2, shown alone in a view identified by reference character Z;

FIG. 4 is the region II of FIG. 1 of a second embodiment, according to the invention, of a valve arrangement; and

FIG. 5 is the region II of FIG. 1 of a third embodiment, according to the invention, of a valve arrangement.

### DESCRIPTION OF THE PREFERRED EMBODIMENTS

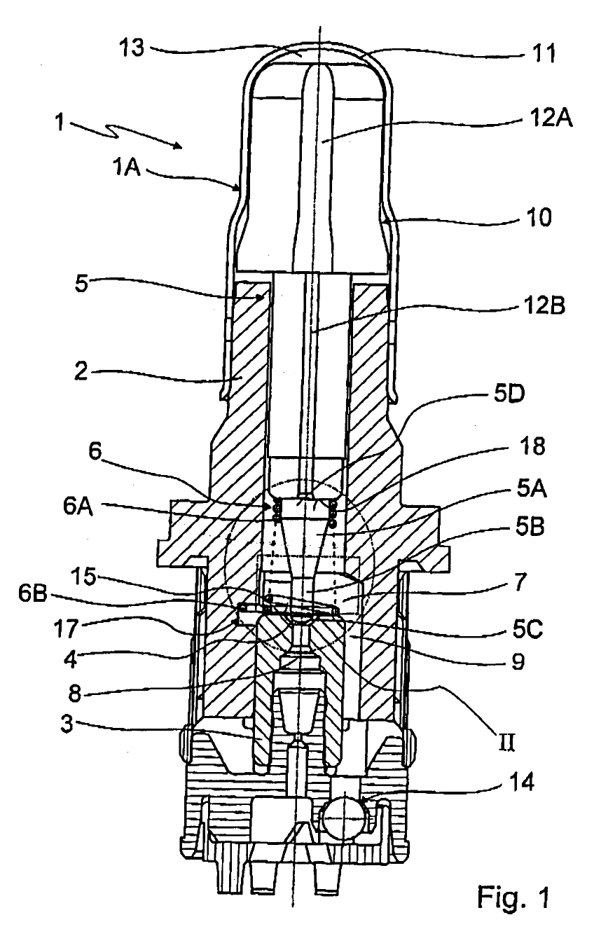

In FIG. 1, the valve arrangement 1 is embodied with a valve element 5 that is disposed longitudinally movably in a valve insert 2 and that cooperates with a valve seat 4 embodied in a valve body. In the installed position, the valve element 5 is acted upon by a spring assembly 6 with a force component acting in the opening direction of the valve seat 4. The valve element 5 is furthermore actuated in the closing direction of the valve seat 4 via an electromagnetic actuator, not shown in detail.

A region of the valve element 5 oriented toward the valve seat 4 is disposed in a valve chamber 7, which is defined by the valve insert 2 in the region of the valve seat; the dimensions of this chamber are shown as a rectangle drawn in dot-dashed lines in FIG. 1. The region of the valve element 5 disposed in the valve chamber 7 has a frustoconical region 5A, a first cylindrical region 5B adjoining the frustoconical region 5A, and a third conical-caplike region 5C in turn adjoining the first cylindrical region 5B. The conical-caplike region 5C of the valve element 5 cooperates with the conically embodied valve seat 4 in such a way that upon contact of the valve element 5 on the valve seat 4, a sealing action prevails of a kind such that an inflow region 8 of the valve chamber 7 and an outflow region 9 of the valve chamber 7 are disconnected from one another when the valve seat 4 is closed.

The valve arrangement 1 substantially comprises the hydraulic module 1A, shown in FIG. 1, and an electrical module, slipped onto the hydraulic module 1A and not further shown, which is embodied in a manner known per se with a coil, an electric winding, and a yoke ring disk, in order to actuate an armature 10 of the hydraulic module 1A, as a so-called electromagnetic actuator, in the closing direction of the valve seat 4 counter to the spring force of the spring assembly 6.

In the present case, the armature 10 is guided longitudinally displaceably in a valve dome 11 solidly connected to the valve insert 2, and together with the valve dome 11 it defines a plurality of conduits 12A, which connects a valve dead space 13, defined between the valve dome 11 and the end of the armature facing away from the valve seat 4, to the valve chamber 7 via tappet grooves 1 2B of the valve element 5.

The valve element 5, in the currentless state of the valve arrangement 1, is thrust away from the valve seat 4 in the direction of the valve dead space 13 by the spring force of the spring assembly 6, which is braced in the axial direction on the end face 15, toward the valve element 5, of the valve body 3, so that the armature 10 is moved away from the valve insert 2 and is pressed against the valve dome 11 in the region of the valve dead space 13 and rests on the valve dome. In this position of both the valve element 5 and the armature 10, the valve seat 4 is uncovered by the valve element 5, or the conical-caplike region 5C of the valve element 5, and the inflow region 8 communicates with the outflow region 9.

In this state of the valve arrangement 1, the operating medium can be delivered, via the valve arrangement 1, or in other words beginning at the inflow region 8 of the valve chamber 7 to the outflow region 9 of the valve arrangement via the valve seat 4, and to a region, communicating with the outflow region 9, of an ABS (anti-lock brake system), TCS (traction control system), or ESP (electronic stability program) system.

To close the valve seat 4, the electrical module, slipped into a known manner onto the valve dome 11, of the valve arrangement 1 is supplied with current such that the electrical module generates an electromagnetic force, which displaces the armature 10 from its position shown in FIG. 1 in the direction of the valve seat 4 and presses the conical-caplike region 5C of the valve element 5 sealingly against the valve seat 4 of the valve body 3.

In this last-described state of the valve arrangement 1, the inflow region 8 is disconnected from the outflow region 9, and no operating medium can be supplied via the valve arrangement 1, if a positive pressure drop exists between the inflow region 8 and the outflow region 9. Here, in the interior of the valve arrangement 1, a positive pressure drop exists between the inflow region 8 and the outflow region 9 if the pressure in the inflow region 8 is greater than the pressure in the outflow region 9 of the valve arrangement 1.

This is due to the fact that the inflow region 8, when there is a positive pressure drop compared to the outflow region 9 and when the valve seat 4 is closed, is disconnected from the outflow region 9 by a check valve 14; at a negative pressure drop, or in other words in the presence of a pressure in the outflow region 9 that is greater than the pressure in the inflow region 8, the check valve 14 is open.

In the valve arrangement 1 shown in FIG. 1, the spring assembly 6 is disposed with its region toward the valve body 3 in the valve chamber 7, through which, when the valve seat 4 is open, fluid or operating medium—or brake fluid in the case where the valve arrangement 1 is used in an ABS system of a motor vehicle—flows from the inflow region 8 in the direction of the outflow region 9.

This in turn means that because it is partly located in the valve chamber 7, the spring assembly 6, embodied with a restoring compression spring, is exposed by the flowing operating medium to both static and dynamic influences. These influences are due, among other things, to flow and deflection forces that engage the spring windings, disposed in the valve chamber 7, of the restoring compression spring of the spring assembly 6; because of varying flow conditions over the operating range of the valve arrangement 1 and dynamically varying spacings between the individual spring windings over the operating range, these forces vary in such a way that the influences that affect the spring assembly 6 are not known.

In FIGS. 1 through 5, several exemplary embodiments of the subject of the invention are shown, in which the spring assembly is positioned in a defined way in its radial position inside the valve arrangement 1 by form- and/or force-locking, in such a way that degrees of freedom of the spring assembly 6 with regard to its position or location inside the valve insert 2 are reduced. As a result, effects associated with the spring position or location of the spring assembly 6 of a static and dynamic nature, such as a change in force from changing length ratios of the spring assembly, its natural frequency, vibration of the spring assembly, radial deflections of the spring assembly, and their effects on components of the valve arrangement 1 that are located adjacent to the spring assembly 6, that is, above all on the valve element 5, are precluded. Thus both the functioning of the valve arrangement 1 and its closed- and open-loop control behavior can be determined in advance substantially more precisely, in comparison to valve arrangements known from the prior art.

In the first exemplary embodiment, shown in FIG. 1, of a valve arrangement 1 embodied according to the invention, the spring assembly 6, embodied with a compression spring or a helical spring 6A, is embodied in the contact region of the spring assembly 6 on the valve body 3 with a diameter such that the helical spring 6A rests in the radial direction at least in some regions on an inside surface 16, defining the valve chamber 7, of the valve insert 2 and is braced in the axial direction on the valve body 3.

The valve insert 2 is furthermore embodied, in the region of the spring end 6B facing toward the valve body 3, with an annular groove 17 that is engaged by a spring end 6B of the spring assembly 6. On its end facing away from the valve body 3, the helical spring 6A rests on an end face 18 of the valve element 5 and is furthermore embodied, in the contact region on the valve element 5, with an inside diameter that corresponds to the outside diameter of a further cylindrical portion 5D of the valve element 5, so that the spring assembly 6 is guided on the valve element 5 in the radial direction.

The helical spring 6A of the spring assembly 6 is embodied with a conical basic shape in cross section, and in the region of its spring end 6B that engages the annular groove 17, it is guided in the radial direction on the valve insert 2; the end face 15 of the valve body 3 is provided as the axial bearing face.

The position of the end face 15 of the valve body 3 in the valve insert 2 is adapted to the position of the annular groove 17 in such a way that the spring assembly 6, even when the valve seat 4 is open, does not lift away from the end face 15 of the valve body 3. On the other hand, both the location and the dimensions of the annular groove 17 should be provided such that a displacement of the valve body 3 relative to the valve insert 2 is possible, to enable adjusting the valve stroke of the valve arrangement 1, without impairing the above-described interaction between the annular groove 17 and the spring assembly 6.

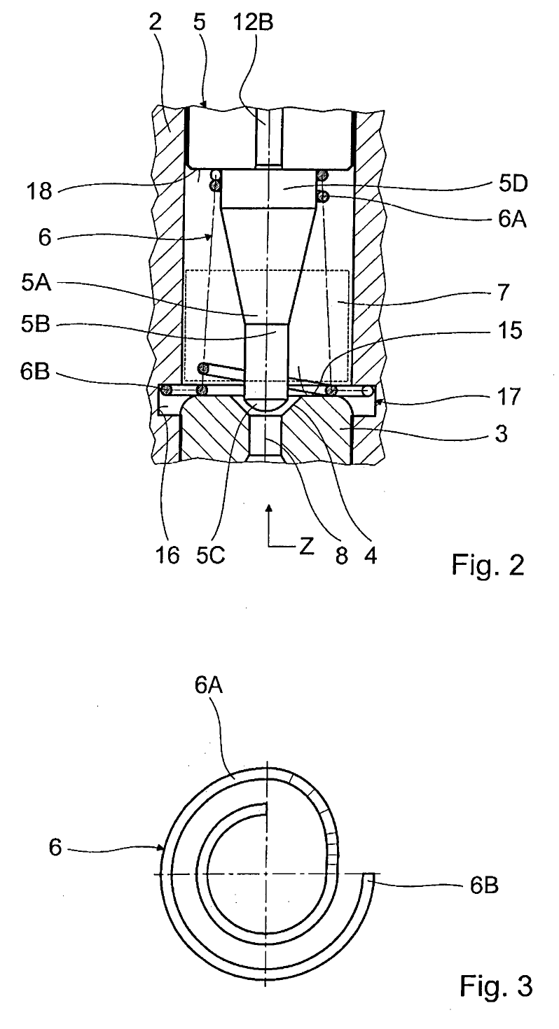

FIG. 2 shows the region II in FIG. 1; the view in FIG. 2 shows an enlarged view of the disposition and dimensioning of the annular groove 17 of the valve insert 2 with respect to the end face 15 of the valve body 3.

In addition, the spring assembly 6 in FIG. 3 is shown from a viewing direction Z in FIG. 2, from which the special embodiment of the spring assembly 6 with the outwardly flared spring end 6B as well as the conical basic shape of the spring assembly 6 are unambiguously visible.

Particularly from the view in FIG. 3, it can be seen that the helical spring 6A is first widened, in the region of the last spring winding toward the valve body 3, to the diameter required for its engagement inside the annular groove 17, and the other spring windings, which are shown graphically only schematically in FIG. 3 by means of the spring winding of the spring assembly 6 that describes a three-quarter circle, have only slight differences in diameter.

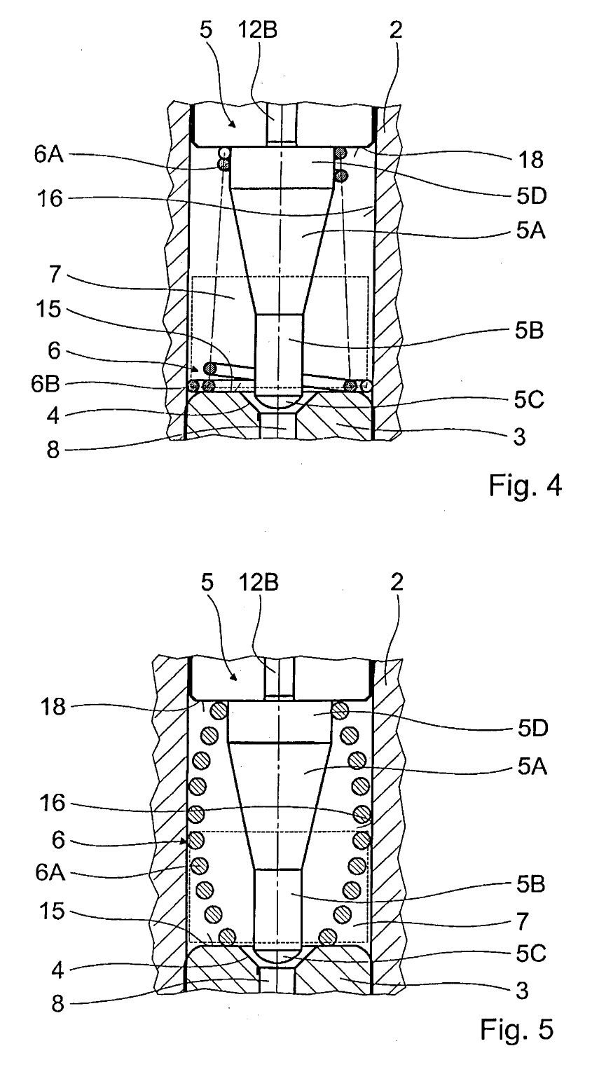

FIG. 4 shows the region II of FIG. 1 in a second embodiment of the invention, in which the spring assembly 6 is again embodied with a substantially conical helical spring 6A. Furthermore, the spring end 6B, toward the valve body 3, of the helical spring 6A is again embodied with a larger diameter than the remaining spring windings of the helical spring 6A.

However, in comparison to the exemplary embodiment of FIGS. 1 and 2, the valve insert 2 is embodied without an annular groove in the region of the valve body 3, so that the helical spring 6A, with its spring end 6B, rests only on the inside 16 of the valve insert 2.

The spring assembly 6 is embodied in the region of the spring end 6B with a diameter such that a force lock exists between the helical spring 6A and the valve insert 2; this force lock counteracts or prevents the spring assembly 6 from lifting away from the end face 15 of the valve body even when the valve seat 4 is open and operating fluid is flowing through the valve chamber 7.

In FIG. 5, an alternative version to the exemplary embodiment shown in FIG. 4 is shown of a valve arrangement of the invention in which the spring assembly 6 is embodied with a helical spring 6A of spherical, crowned or barrel-shaped cross section. With this kind of helical spring, the possibility now exists of guiding the spring assembly 6 in the radial direction in the valve insert 2 between the contact region of the spring assembly 6 on the valve element 5 and the contact region of the spring assembly 6 on the valve body 3. Thus a fixation of the spring assembly 6 in approximately the middle of the helical spring 6A, in terms of the axial length of the spring assembly 6, can be accomplished, and thus the spring can be embodied symmetrically and can be installed in a simple way without taking its installed position into account.

Beyond the scope of the force-locking fixation of the spring assembly 6 in the valve insert 2 as shown in FIGS. 4 and 5, influence can be exerted on the vibrational, noise and closed-loop control behavior of the valve arrangement 1 embodied as a magnet valve, since because of the force-locking fixation, the natural frequency of the spring assembly is influenced.

It is understood that it is within the judgment of one skilled in the art to guide the spring assembly in the manner shown in FIG. 2 or FIG. 4 in the contact region of the spring assembly on the valve insert in the radial direction, and in addition, via a spherical embodiment of the spring assembly in some regions, also to brace it in a reinforced way in the radial direction in the valve insert at some other point between the contact regions of the spring assembly on the valve element and on the valve body.

The foregoing relates to preferred exemplary embodiments of the invention, it being understood that other variants and embodiments thereof are possible within the spirit and scope of the invention, the latter being defined by the appended claims.

1. In a valve arrangement having a valve element, which is disposed longitudinally movably in a valve insert and cooperates with a valve seat embodied in a valve body, which valve element in the installed position is acted upon, by a spring assembly disposed between the valve body and the valve insert, with a force component acting in the opening direction of the valve seat and is actuatable in the closing direction of the valve seat via an electromagnetic actuator, and the spring assembly is guided in the radial direction in the region of a bearing face on the valve element, the improvement wherein the spring assembly, between its contact region on the valve element and its contact region on the valve body, is guided in at least one further region in the radial direction on the valve insert.

2. The valve arrangement according to claim 1, wherein the spring assembly comprises with a helical spring, whose spring end, facing toward the valve body, is embodied with a diameter such that the helical spring rests at least in some regions in the radial direction, on the inside of the valve insert, which inside defines the valve chamber, and the helical spring is braced in the axial direction on the valve body.

3. The valve arrangement according to claim 2, wherein the valve insert, in the region of the spring end facing toward the valve body, is embodied with an annular groove, which is engaged by the spring end.

4. The valve arrangement according to claim 2, wherein the helical spring is embodied cylindrically in at least some regions.

5. The valve arrangement according to claim 3, wherein the helical spring is embodied cylindrically in at least some regions.

6. The valve arrangement according to claim 2, wherein the helical spring is embodied conically in at least some regions.

7. The valve arrangement according to claim 3, wherein the helical spring is embodied conically in at least some regions.

8. The valve arrangement according to claim 4, wherein the helical spring is embodied conically in at least some regions.

9. The valve arrangement according to claim 5, wherein the helical spring is embodied conically in at least some regions.

10. The valve arrangement according to claim 2, wherein the helical spring is embodied barrel-shaped in at least some regions.

11. The valve arrangement according to claim 3, wherein the helical spring is embodied barrel-shaped in at least some regions.

12. The valve arrangement according to claim 4, wherein the helical spring is embodied barrel-shaped in at least some regions.

13. The valve arrangement according to claim 5, wherein the helical spring is embodied barrel-shaped in at least some regions.

14. The valve arrangement according to claim 6, wherein the helical spring is embodied barrel-shaped in at least some regions.

15. The valve arrangement according to claim 7, wherein the helical spring is embodied barrel-shaped in at least some regions.

16. The valve arrangement according to claim 8, wherein the helical spring is embodied barrel-shaped in at least some regions.

17. The valve arrangement according to claim 9, wherein the helical spring is embodied barrel-shaped in at least some regions.
